(19) United States
(12) Patent Application Publication
(10) Pub. No.: US 2008/0088633 A1
(43) Pub. Date: Apr. 17, 2008

(54) Apparatus and method for providing data

(76) Inventors: Chih-Yen Lin, Changhua Hsien (TW); Po-Cheng Wu, Changhua City (TW)

Correspondence Address: CHRISTIE, PARKER & HALE, LLP, PO BOX 7068, PASADENA, CA, 91109-7068, US

(21) Appl. No.: 11/648,387

(22) Filed: Dec. 28, 2006

(30) Foreign Application Priority Data
Oct. 12, 2006 (TW) 095137505

(51) Int. Cl. G06F 13/14

(52) U.S. Cl. 345/520

(57) ABSTRACT

A data providing apparatus stores data waiting to be rendered, and communicates with a data rendering apparatus through a commonly supported standard. The data providing apparatus includes a digital media controller (DMC) for controlling the data rendering apparatus, a controller outputting the data waiting to be rendered, a converter converting the data waiting to be rendered to be suitable for the data rendering apparatus, and a streaming server receiving the converted data. The controller controls the data rendering apparatus through the DMC such that the streaming server transmits the converted data to the data rendering apparatus. A data providing method is also disclosed.

### CROSS-REFERENCE TO RELATED APPLICATION

This application claims priority of Taiwanese Application No. 095137505, filed on Oct. 12, 2006.

### BACKGROUND OF THE INVENTION

1. Field of the Invention

The present invention relates to an apparatus and method for providing data, more particularly to an apparatus and method for providing data that are compatible with the Universal Plug and Play (UPnP) standard.

2. Description of the Related Art

UPnP is a standard related to computer network protocols and that is supervised by the Digital Living Network alliance (DLNA). The goal of UPnP is to establish a wired and wireless interoperable network of personal computers, consumer electronics, and mobile devices in the home or office that enables a seamless environment for data communications.

Referring to FIG. 1, an example of the interoperation between electronic devices supporting the UPnP standard will now be described. In this example, a display device 8 and a digital camera cell phone (hereafter referred to as a camera phone) 7 both support the UPnP standard, and are connected to a home network that is established based on the UPnP architecture. When it is desired to display digital images stored in the camera phone 7 on the display device 8, no configuration need be performed by the user. That is, through the seamless connectivity offered by UPnP, each of the camera phone 7 and the display device 8 is aware of the presence and capabilities of the other device, and is able to communicate with the other device. Hence, simple user manipulation of the camera phone 7 and/or the display device 8 is sufficient to display the digital pictures stored in the camera phone 7 on the display device 8.

Continuing with this example, with reference to FIG. 2, the camera phone 7 includes a digital media server (DMS) 71 and a digital media controller (DMC) 72, and the display device 8 includes a digital media renderer (DMR) 82 and a screen 82. The DMS 71, in turn, includes a content directory service (CDS) 711, and a streaming server 712 electrically coupled to the CDS 711. The COS 711 exposes digital images stored in the camera phone 7 to the home network (not shown), and the streaming server 712 outputs the digital images stored in the camera phone 7 to the home network. The streaming server 712 supports the hypertext transfer protocol (HTTP).

The DMR 81 renders the digital images on the screen 82. The DMC 72 browses the digital images exposed by the CDS 711 of the DMS 71, searches for the DMR 81 in the home network having the capability of rendering the digital images exposed by the CDS 711, and establishes a peer-to-peer connection between the streaming server 712 and the DMR 81 to enable uploading of the digital images stored in the camera phone 7 to the DMR 81.

The process for displaying the digital images of the conventional camera phone 7 on the display device 8 is described in the following with further reference to FIG. 3.

In step 91, the DMS 71 receives and stores a playlist established by the user. The playlist includes a set of digital images selected by the user and waiting to be displayed. Further, the CDS 711 of the DMS 71 exposes the data stored in the camera phone 7 to the home network.

In step 92, the DMC 72 receives an instruction from the user to select the playlist from the data stored by the DMS 71 and exposed by the CDS 711 of the DMS 71.

In step 93, the DMC 72 establishes a connection between the streaming server 712 of the DMS 71 and the DMR 81, and sets a uniform resource identifier (URI) of the DMR 81 as the streaming server 712 of the DMS 71.

In step 94, the DMC 72 controls the DMR 81 to initiate the process for displaying the digital images.

In step 95, the DMR 81 issues a request to the streaming server 712 of the DMS 71 through the HTTP protocol to download a digital image so that a digital image in the playlist is obtained from the OMS 71.

In step 96, the DMR 81 renders the digital image through the screen 82, after which the flow returns to step 93 so as to begin downloading of a subsequent digital image.

Some of the drawbacks of the conventional UPnP compatible camera phone 7 are as follows:

1. It is necessary for the user to select digital images waiting to be displayed in step 91 to establish the playlist, and, in step 92, to again select the playlist from the data stored in the DMS 71. Hence, the user must perform a selection operation two times.

2. The camera phone 7 is incapable of performing any conversion processing. So, for example, if the digital images of the DMS 71 are in a format or have a resolution that are unsuitable for optimal rendering by the display device 8, the display quality of the digital images is low.

3. The camera phone 7 outputs the digital images to the display device 8 without providing any display effect thereto. For example, if a transition effect were provided to the digital images, in which a presently displayed digital image is faded out and a subsequently displayed digital image is faded in, the user would enjoy an enhanced viewing experience. Since no such display effect is provided, however, the display of the digital images is dull and simplistic.

4. In steps 93 to 96, after the DMR 81 receives a digital image, it is necessary for the DMC 72 to again set the URI of the DMR 81 as the streaming server 712 of the DMS 71 so as to allow for downloading of a subsequent digital image. This complicates, and therefore slows down, the entire rendering process.

### SUMMARY OF THE INVENTION

Therefore, the object of this invention is to provide a data providing apparatus and a data providing method that overcome the aforesaid drawbacks of the prior art.

According to one aspect, the data providing apparatus of this invention has data waiting to be rendered stored therein, and is adapted to communicate with a data rendering apparatus through a standard supported by both the data providing apparatus and the data rendering apparatus. The data providing apparatus of this invention comprises: a digital media controller (DMC) adapted to control the data rendering apparatus for rendering data; a controller electrically coupled to the DMC, and outputting the data waiting to be rendered; a converter electrically coupled to the controller and converting the data waiting to be rendered that are output by the controller into converted data that are suitable for rendering by the data rendering apparatus, the converter outputting the converted data; and a streaming server electrically coupled to the controller and the converter, the streaming server receiving the converted data from the converter.

The controller controls the data rendering apparatus through the DMC to output a download request to the streaming server so that the streaming server, upon receipt of the download request, transmits the converted data to the data rendering apparatus.

According to another aspect of this invention, the data providing method is implemented by the data providing apparatus, and comprises: a) calling the data rendering apparatus to initiate a process of rendering the data waiting to be rendered; b) converting the data waiting to be rendered into converted data that are suitable for rendering by the data rendering apparatus; and c) controlling the data rendering apparatus to download the converted data from the data providing apparatus.

### BRIEF DESCRIPTION OF THE DRAWINGS

Other features and advantages of the present. invention will become apparent in the following detailed description of the preferred embodiment with reference to the accompanying drawings, of which:

FIG. 1 is a schematic diagram used for describing the interoperation between conventional electronic devices supporting the UPnP standard;

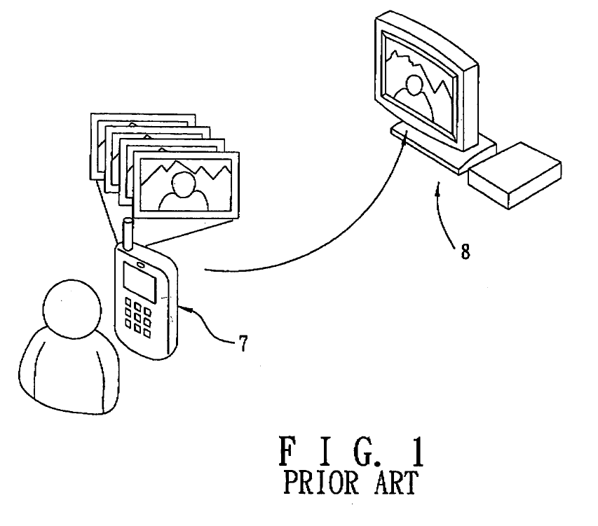

FIG. 2 is a schematic circuit block diagram, illustrating an electrical coupling relationship between a conventional data providing apparatus and a conventional data rendering apparatus;

FIG. 3 is a flow chart of steps involved in a conventional method for providing data performed by the data providing apparatus of FIG. 2;

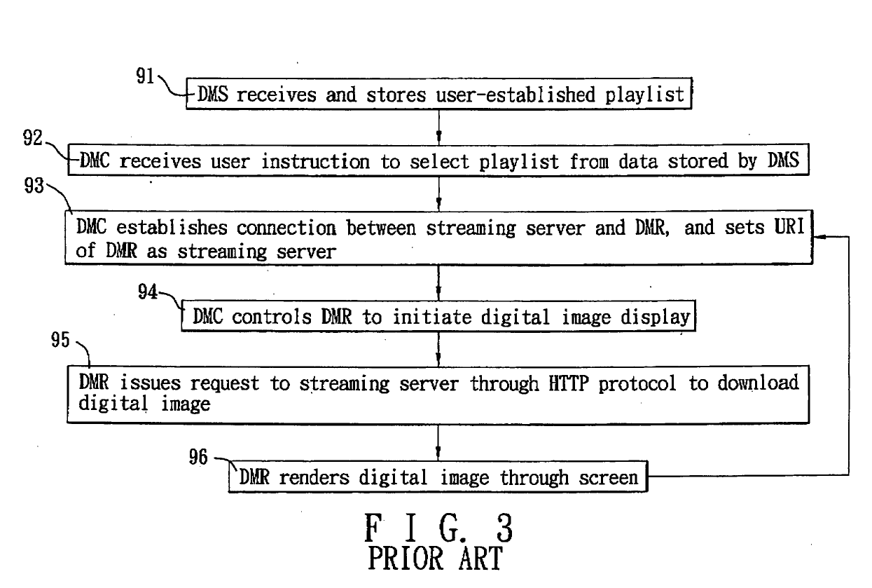

FIG. 4 is a schematic circuit block diagram, illustrating an electrical coupling relationship between a data providing apparatus according to a preferred embodiment of the present invention and a corresponding data rendering apparatus;

FIG. 5 is a flow chart of steps involved in a method for providing data performed by the data providing apparatus of FIG. 4 according to a preferred embodiment of the present invention; and

FIG. 6 is a schematic diagram illustrating directional flows of data, requests, and messages between pairs of elements of the data providing apparatus of the preferred embodiment, as well as interaction with a user, in which the passage of time is conceptually in the downwardly vertical direction.

### DETAILED DESCRIPTION OF THE PREFERRED EMBODIMENT

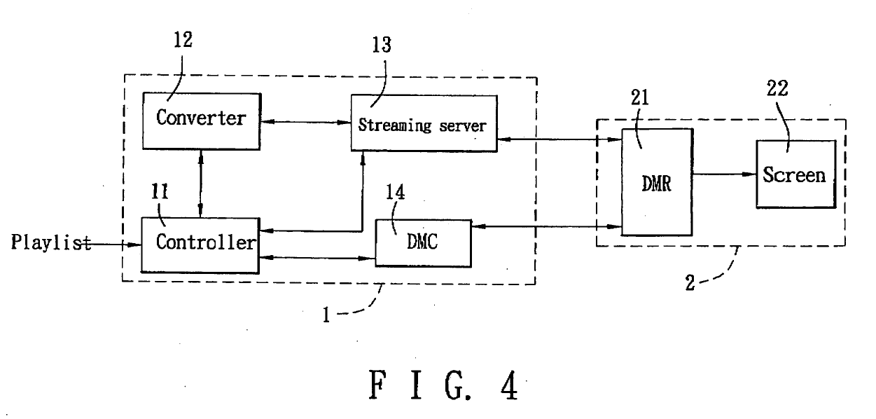

Referring to FIG. 4, a data providing apparatus 1 according to a preferred embodiment of the present invention is adapted to communicate with a data rendering apparatus 2 through the UPnP standard supervised by DLNA. The data providing apparatus 1 has data waiting to be rendered stored therein, and includes a controller 11, a converter 12, a streaming server 13, and a DMC 14.

In this embodiment, the data waiting to be rendered stored in the data providing apparatus 1 include digital images. However, the present invention is not limited in this regard, and the data waiting to be rendered may include other types of data, such as voice data.

The data rendering apparatus 2 includes a data-rendering module and a DMR 21. The data-rendering module is assumed to be a screen 22 for the purposes of this embodiment. That is, depending on what form the data waiting to be rendered takes or what type of data are included therein, the data-rendering module may be varied with respect to device type. For example, when the data waiting to be rendered include voice data, the data-rendering module may be a speaker assembly that includes a DMR.

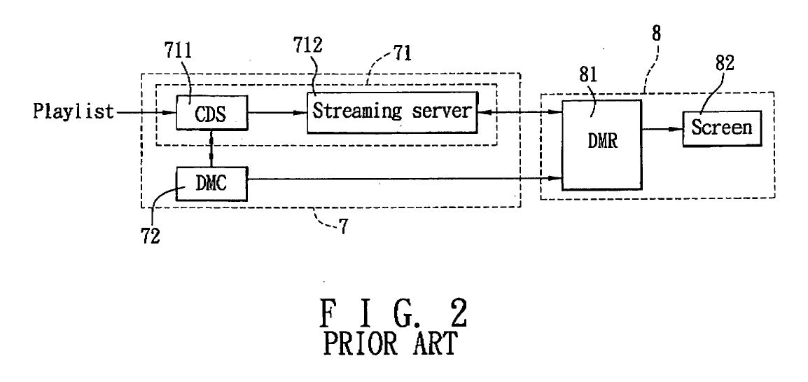

The DMC 14 and the streaming server 13 are similar to the conventional DMC 72 and streaming server 712 (see FIG. 2), respectively. In general terms, the DMC 14 is adapted to control the data rendering apparatus 2 for rendering data. The full operation of the streaming server 13 and the detailed operation of the DMC 14 will become apparent from the description to follow, particularly from the description of a method for providing data of the present invention.

The controller 11 is electrically coupled to the DMC 14, the streaming server 13, and the converter 12. The controller 11 receives user input of a playlist to thereby establish the data waiting to be rendered that are stored in the data providing apparatus 1. For example, the data providing apparatus 1 may have source data stored therein, and the user may select a portion of the source data as the playlist to thereby establish the data waiting to be rendered. The data waiting to be rendered are output by the controller 11 to the converter 12 through control by the streaming server 13, and are downloaded by the DMR 21 through control by the DMC 14.

The converter 12 converts the data waiting to be rendered that are output by the controller 11 into converted data that are suitable for rendering by the DMR 21 of the data rendering apparatus 2. It is to be noted that the controller 11 may determine the manner in which the converter 12 is to perform conversion, i.e., what constitutes conversion so that the data waiting to be converted are suitable for rendering by the DMR 21, through, for example, the “discovery” or “description” processes common to UPnP networking.

After conversion, the converter 12 outputs the converted data to the streaming server 13. The converter 12 may perform conversion so as to, for example, adjust resolution, change format, add background music, and add display effects. In this embodiment, the converter 12 converts there solution and format of the data waiting to be rendered to result in the converted data.

The streaming server 13 is coupled to the converter 12 and the DMR 21, in addition to its electrical coupling to the controller 11. The streaming server 13 receives the converted data output by the converter 12, and transmits the converted data to the data rendering apparatus 2. In particular, the controller 11 controls the data rendering apparatus 2 through the DMC 14 to output a download request to the streaming server 13 so that the streaming server 13, upon receipt of the download request, transmits the converted data to the data rendering apparatus 2.

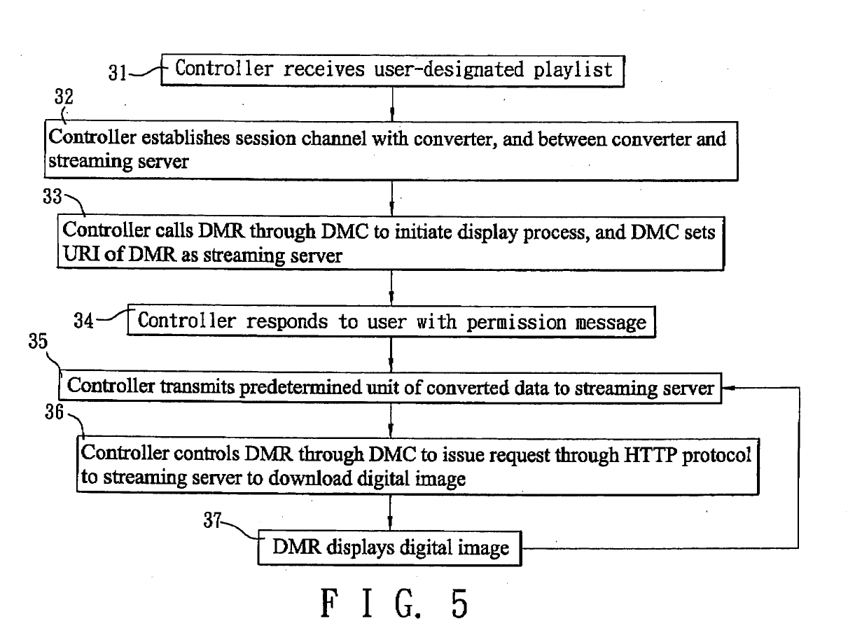

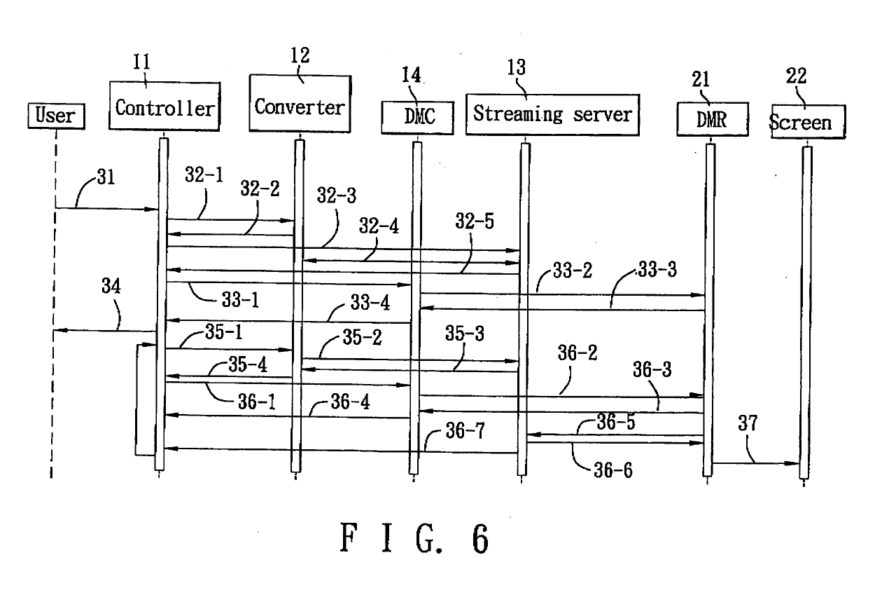

Referring to FIGS. 5 and 6, the method for providing data of the preferred embodiment will now be described. The data providing method is implemented by the data providing apparatus 1 of the present invention.

In step 31, the controller 11 receives a user-designated playlist to thereby establish the data waiting to be rendered.

In step 32, the controller 11. establishes a session channel with the converter 12, and between the converter 12 and the streaming server 13 so that the data waiting to be rendered output by the controller 11 may be transmitted to the streaming server 13. Step 32 includes five sub-steps 32-1 to 32-5.

In sub-step 32-1, the controller 11 outputs a request to the converter 12 to establish a session channel therewith so that the data waiting to be rendered can be output from the controller 11 to the converter 12.

Subsequently, in sub-step 32-2, the converter 12 responds to the controller 11 with a permission message.

Next, in sub-step 32-3, the controller 11 outputs a request to the streaming server 13 to establish a session channel between the converter 12 and the streaming server 13 so that the converter 12 is able to transmit the data waiting to be rendered to the streaming server 13.

Next, in sub-step 32-4, the streaming server 13 establishes a session channel with the converter 12.

Subsequently, in sub-step 32-5, the streaming server 13 responds with a message to the controller 11 to indicate successful establishment of a session channel with the converter 12.

In step 33, the controller 11 calls the DMR 21 through the DMC 14 to initiate the process to display the data waiting to be rendered, and the DMC 14 sets the URI of the DMR 21 as the streaming server 13 such that the DMR 21 is able to download digital images from the streaming server 13. Step 33 includes four sub-steps 33-1 to 33-4.

In sub-step 33-1, the controller 11 outputs a display request to the DMC 14.

Subsequently, in sub-step 33-2, the DMC 14 outputs to the DMR 21 a request to set an AV (Audio and Video) Transport URI as the streaming server 13.

Next, in sub-step 33-3, the DMR 21 responds to the DMC 14 with a permission message.

Finally, in sub-step 33-4, the DMC 14, in accordance with the permission message of sub-step 33-3, responds with a message to the controller 11.

In step 34, the controller 11 responds to the user with a permission message.

In step 35, the controller 11 transmits a predetermined unit of the converted data to the streaming server 13 through the converter 12. In this embodiment, the predetermined unit of the converted data is a digital image. Step 35 includes four sub-steps 35-1 to 35-4.

In sub-step 35-1, the controller 11 outputs a digital image to the converter 12.

In sub-step 35-2, the converter 12 transmits through the session channel established in step 32 the converted digital image to the streaming server 13 for temporary storage therein.

In sub-step 35-3, the streaming server 13 responds to the converter 12 with a permission message.

In sub-step 35-4, the converter 12 responds to the controller 11 with a permission message.

In step 36, the controller 11 controls the DMR 21 through the DMC 14 to issue a request through the HTTP protocol to the streaming server 13 to download a digital image to thereby obtain a digital image. Step 3E includes seven sub-steps 36-1 to 36-7.

In sub-step 36-1, the controller 11 outputs a display request to the DMC 14.

Next, in sub-step 36-2, the DMC 14, in accordance with the display request, instructs the DMR 21 to download a digital image from the streaming server 13.

Subsequently, in sub-step 36-3, the DMR 21 responds to the DMC 14 with a permission message.

Next, in sub-step 36-4, the DMC 14, in accordance with the permission message of the DMR 21, responds to the controller 11 with a permission message.

Next, in sub-step 36-5, the DMR 21 outputs a request to the streaming server 13 to download a digital image.

Subsequently, in sub-step 36-6, the streaming server 13 transmits a digital image to the DMR 21.

Finally, in sub-step 36-7, the streaming server 13 responds to the controller 11 that downloading is finished.

In step 37, the DMR 21 displays the digital image, after which the flow returns to step 35 such that a subsequent digital image may be output for downloading by the data rendering apparatus 2.

In one embodiment, prior to step 32 (i.e., prior to outputting of the data waiting to be rendered by the controller 11 to the converter 12), the controller 11 applies a template of a photo slide show stored therein to the data waiting to be rendered. In the case where the data waiting to be rendered include digital images, the template of a photo slide show is applied to the digital images. Application of the template of the photo slide show to the data waiting to be rendered is such that a plurality of screen frames with a transition effect provided between adjacent pairs of the screen frames are formed. In this case, the controller 11 outputs the screen frames to the converter 12 in step 32.

In sub-steps 35-1 to 35-4, a digital image that has undergone conversion processing is transmitted to the streaming server 13 for temporary storage therein, after which the streaming server 13 transmits the digital image to the DMR 21. However, the present invention is not limited in this respect. For example, the digital image may be transmitted by the controller 11 to the converter 12 for temporary storage therein, and when the DMR 21 is controlled to download a digital image from the streaming server 13, the streaming server 13 downloads a converted digital image from the converter 12 and transmits the digital image to the DMR 21.

The data providing apparatus 1 and the data providing method of the present invention have the following advantages:

1. The DMC 14 needs to set the URI of the DMR 21 as the streaming server 13 only once in step 33, and it is unnecessary to perform such setting of the URI of the DMR 21 each time after the DMR 21 downloads a digital image as in the case of the conventional apparatus and method.

2. The template is applied to the data waiting to be rendered, i.e., the digital images in the preferred embodiment, to thereby result in the formation of a plurality of screen frames having a transition effect between the digital images. Hence, the digital images are displayed through the data rendering apparatus 2 in a manner having a more lively and sophisticated visual effect.

3. Since the controller 11 directly transmits to the converter 12 the data waiting to be rendered established by the playlist designated by the user, it is unnecessary for the user to again perform any selection with respect to the playlist as in the conventional apparatus and method. Therefore, the data providing apparatus 1 of the present invention may be easily operated by the user.

4. The DMS 71 of the conventional data providing apparatus 7 (see FIG. 2) is unneeded in the present invention, and only the streaming server 13 is required. This simplifies the structure of the data providing apparatus 1 and, ultimately, the manufacture of the same.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A data providing apparatus having data waiting to be rendered stored therein, and adapted to communicate with a data rendering apparatus through a standard supported by both said data providing apparatus and the data rendering apparatus, said data providing apparatus comprising:
a digital media controller (DMC) adapted to control the data rendering apparatus, for rendering data;
a controller electrically coupled to said DMC, and outputting the data waiting to be rendered;
a converter electrically coupled to said controller and converting the data waiting to be rendered that are output by said controller into converted data that are suitable for rendering by the data rendering apparatus, said converter outputting the converted data; and
a streaming server electrically coupled to said controller and said converter, said streaming server receiving the converted data from said converter;
said controller controlling the data rendering apparatus through said DMC to output a download request to said streaming server so that said streaming server, upon receipt of the download request, transmits the converted data to the data rendering apparatus.

2. The data providing apparatus of claim 1, wherein said DMC is adapted to set a uniform resource identifier of the data rendering apparatus as said data providing apparatus.

3. The data providing apparatus of claim 1, wherein said streaming server outputs a request to said controller to output a predetermined unit of the data waiting to be rendered to said converter, and following completion of downloading a corresponding predetermined unit of the converted data by the data rendering apparatus, said streaming server requests said controller to output a subsequent predetermined unit of the data waiting to be rendered to said converter.

4. The data providing apparatus of claim 1, wherein said controller has a template of a photo slide show stored therein, said controller applying the template to the data waiting to be rendered to form a plurality of screen frames with a transition effect provided between adjacent pairs of the screen frames, said controller outputting the screen frames to said converter.

5. The data providing apparatus of claim 1, wherein the data waiting to be rendered include digital images.

6. The data providing apparatus of claim 5, wherein said controller has a template of a photo slide show stored therein, said controller applying the template to the digital images to form a plurality of screen frames with a transition effect provided between adjacent pairs of the screen frames, said controller outputting the screen frames to the converter.

7. The data providing apparatus of claim 1, wherein the standard supported by the data rendering apparatus and said data providing apparatus is the Universal Plug and Play (UPnP) standard supervised by the Digital Living Network Alliance (DLNA).

8. The data providing apparatus of claim 1, wherein said converter converts at least one of a resolution and a format of the data waiting to be rendered to result in the converted data.

9. A data providing method to be implemented by a data providing apparatus having data waiting to be rendered stored therein, the data providing apparatus communicating with a data rendering apparatus through a standard supported by the data providing apparatus and the data rendering apparatus, said data providing method comprising:
a) calling the data rendering apparatus to initiate a process of rendering the data waiting to be rendered;
b) converting the data waiting to be rendered into converted data that are suitable for rendering by the data rendering apparatus; and
c) controlling the data rendering apparatus to download the converted data from the data providing apparatus.

10. The data providing method of claim 9, further comprising setting a uniform resource identifier of the data rendering apparatus as the data providing apparatus after step a).

11. The data providing method of claim 9, wherein, in step c), the data providing apparatus outputs a predetermined unit of the converted data for downloading by the data rendering apparatus, and following completion of downloading the predetermined unit of the converted data by the data rendering apparatus, the data providing apparatus outputs a subsequent predetermined unit of the converted data for downloading by the data rendering apparatus.

12. The data providing method of claim 9, further comprising, prior to step b), applying a template of a photo slide show to the data waiting to be rendered to form a plurality of screen frames with a transition effect provided between adjacent pairs of the screen frames.

13. The data providing method of claim 9, wherein the data waiting to be rendered include digital images.

14. The data providing method of claim 13, further comprising, prior to step b), applying a template of a photo slide show to the digital images to form a plurality of screen frames with a transition effect provided between adjacent pairs of the screen frames.

15. The data providing method of claim 9, wherein the standard supported by the data rendering apparatus and the data providing apparatus is the Universal Plug and Play (UPnP) standard supervised by the Digital Living Network Alliance (DLNA).

16. The data providing method of claim 9, wherein, in step b), at least one of a resolution and a format of the data waiting to be rendered is converted.
